(19) United States
(12) Patent Application Publication
(10) Pub. No.: US 2011/0026283 A1
(43) Pub. Date: Feb. 3, 2011

(54) POWER SYSTEM INTERCONNECTION SYSTEM AND POWER CONVERTING METHOD

(75) Inventor: Norio OKADA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Renesas Electronics Corporation, Kawasaki (JP)

(21) Appl. No.: 12/826,216

(22) Filed: Jun. 29, 2010

(30) Foreign Application Priority Data
Jul. 31, 2009 (JP) 2009-179863

(51) Int. Cl. H02M 7/44

(52) U.S. Cl. 363/74

(57) ABSTRACT

A power system interconnection system includes: a voltage detecting section configured to detect voltage values of a power system line to generate detection voltage values; and a PWM signal generating section configured to generate a PWM signal such that an output voltage follows the detection voltage values. A voltage converting circuit is configured to generate and supply the output voltage to the power system line by performing a pulse-width-modulation control on the power supplied from a power supply based on the PWM signal.

### INCORPORATION BY REFERENCE

This patent application claims a priority on convention based on Japanese Patent Application No. 2009-179863 filed on July 31, 2009. The disclosure thereof is incorporated herein by reference.

### TECHNICAL FIELD

The present invention relates to a power system interconnection system.

### BACKGROUND ART

A technique has been developed which converts electric power generated by photovoltaic power generation, wind power generation, or the like into power with the same characteristics as those of a power system. In order to achieve system interconnection of DC power generated by a DC power generator such as a photovoltaic power generator, it is important to keep power loss small. When the system power is of an AC waveform, it is further required to reduce a delay and to make phase adjustment.

Patent literature 1 describes an inverter apparatus for system interconnection of output of a solar battery. In a technique described in this patent literature 1, MPPT (maximum power point tracking) control is performed to keep power loss small.

### Citation List:

[patent literature 1]: JP 2000-20150A

### SUMMARY OF THE INVENTION

In performing system interconnection, a waveform of AC power of a system may have no ideal sine-wave. For example, in the system power line in home, the waveform varies in accordance with a load of an electric appliance. Even for system interconnection with such a system power having no ideal sine-wave, a power conversion technique with less power loss and a high efficiency is desired.

In an aspect of the present invention, a power system interconnection system includes: a voltage detecting section configured to detect voltage values of a power system line to generate detection voltage values; a PWM signal generating section configured to generate a PWM signal such that an output voltage follows the detection voltage values; and a voltage converting circuit configured to generate and supply the output voltage to the power system line by performing a pulse-width-modulation control on the power supplied from a power supply based on the PWM signal.

In another aspect of the present invention, a microcontroller includes: a voltage acquiring section configured to acquire detection voltage values generated by detecting a voltage of a system power line; a PWM signal generating section configured to generate a PWM signal for an output voltage to follow the voltage detection values; and an output section configured to output the PWM signal to a voltage converting circuit which generates and supplies the output voltage to the system power line by performing PWM modulation on power supplied from a power supply based on the PWM signal.

In still another aspect of the present invention, a power converting method is achieved by: detecting a voltage of a system power line to generate detection voltage values; by generating a PWM signal for an output voltage to follow the detection voltage values; and by outputting the PWM signal to a voltage converting circuit which generates and supplies the output voltage to the system power line by performing PWM modulation on power supplied from a power supply based on the PWM signal.

The present invention provides a power conversion technique with little power loss and a high efficiency even for interconnection with a system power having no ideal sine-wave.

### BRIEF DESCRIPTION OF DRAWINGS

The above and other objects, advantages and features of the present invention will be more apparent from the following description of certain embodiments taken in conjunction with the accompanying drawings, in which:

FIG. 1 is a block diagram showing a configuration of a power system interconnection system;

FIG. 2A shows a voltage boosting chopper circuit;

FIG. 2B shows a voltage reducing chopper circuit;

FIG. 3 shows a configuration of a power converting section in a first embodiment of the present invention;

FIG. 4 is a flowchart showing an operation of a microcontroller;

FIG. 5A shows an example of an input waveform and an output waveform;

FIG. 5B shows an example of an input waveform and an output waveform; and

FIG. 6 shows a configuration of the power converting section in a second embodiment of the present invention.

### DESCRIPTION OF EMBODIMENTS

Hereinafter, a power system interconnection system of the present invention will be described with reference to the attached drawings.

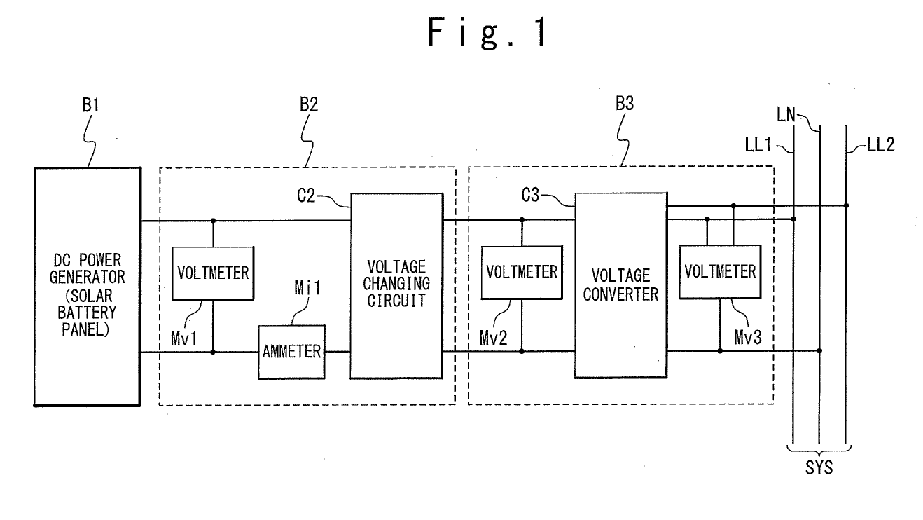

FIG. 1 is a block diagram illustrating a configuration of the power system interconnection system according to the present invention. A DC power generator B1 is a power supply that supplies a DC power, and includes a solar battery panel and its array unit. The DC power outputted by the DC power generator B1 is supplied to a voltage control section B2.

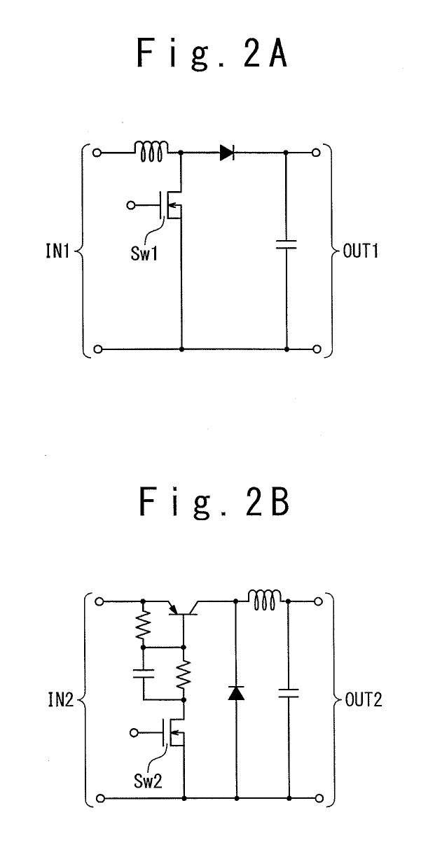

The voltage control section B2 is provided with a voltage changing circuit C2 such as a voltage boosting circuit (FIG. 2A) or a voltage reducing circuit (FIG. 2B). When a system-side voltage is considerably lower than a voltage generated by the DC power generator B1, a voltage reducing circuit is used as the voltage changing circuit instead of the voltage boosting circuit C2. The voltage control section B2 is provided with a voltmeter Mv1 and an ammeter Mi1. The voltmeter Mv1 measures voltage of the power supplied from the DC power generator B1 on a front side of the voltage changing circuit C2 to generate time-series voltage value data. The ammeter Mi1 measures current of the power supplied from the DC power generator B1 to generate time-series current value data. The voltage control section B2 controls the voltage changing circuit C2 based on the voltage value data generated by the voltmeter Mv1 and the current value data generated by the ammeter Mi1, to perform maximum power point tracking control of the DC power generator B1.

The voltage changing circuit C2 such as the voltage boosting circuit can be realized by a configuration of a typical voltage boosting circuit. As one example, a typical voltage boosting chopper circuit is shown in FIG. 2A. The voltage boosting circuit C2 is provided with a control section (not shown) that performs PWM control. This control section controls ON/OFF of a switching element Sw1, whereby the voltage outputted from the DC power generator B1 and supplied from input terminals IN1 is boosted to a target voltage which is outputted from output terminals OUT1.

Also, when the voltage control section B2 is provided with the voltage reducing circuit C2 instead of the voltage boosting circuit, it can be realized by a configuration of a typical voltage reducing circuit. As one example, a typical voltage reducing chopper circuit is shown in FIG. 2B. The voltage reducing circuit is provided with a control section (not shown) that performs PWM control. This control section controls ON/OFF of a switching element Sw2, whereby the voltage outputted by the DC power generator B1 and supplied from input terminals IN1 is reduced to the target voltage which is outputted from output terminals OUT2.

A power converting section B3 receives the voltage outputted from the voltage changing circuit C2. The received voltage is converted into a voltage suitable for system interconnection and then outputted from the voltage converter C3. In the present invention, the power outputted from the power converting section B3 is supplied to a system power line SYS of a single-phase 3-wire AC power transmission type, which includes a pair of external lines LL1 and LL2 and one neutral line LN.

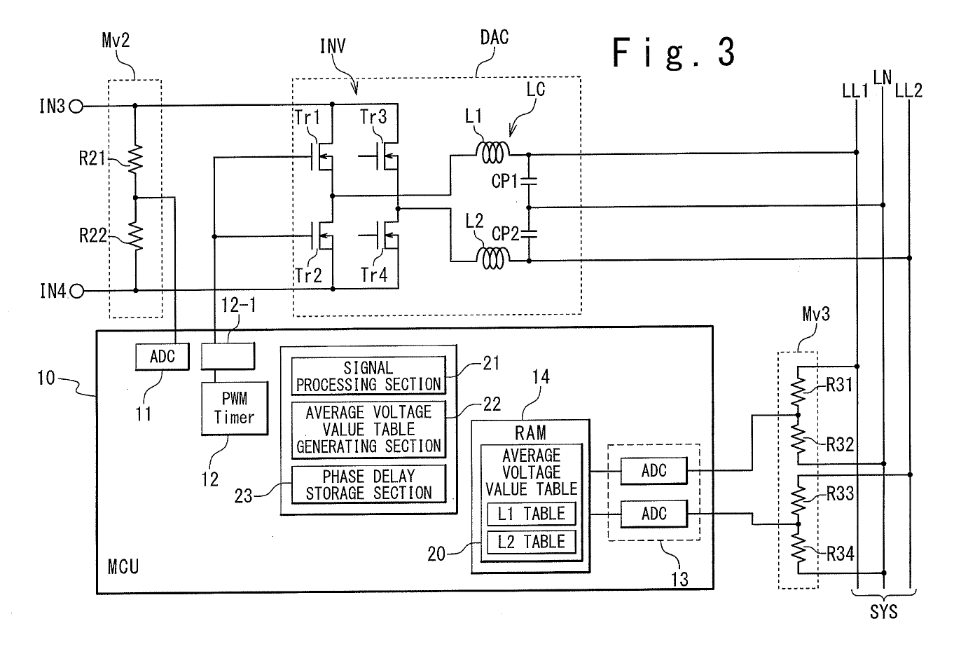

FIG. 3 shows a configuration of the power converting section B3 in a first embodiment of the present invention. The power converting section B3 is provided with input terminals IN3 and IN4 to which power outputted from the voltage control section B2 is supplied. The power converting section B3 is further provided with a voltmeter Mv2 for always monitoring and detecting a voltage between the input terminal IN3 and the input terminal IN4 in real time. The voltmeter Mv2 in the present embodiment has a resistor element R21 and a resistor element R22 connected in serial between the input terminal IN3 and the input terminal IN4 for the purpose of generating a divided voltage.

The power converting section B3 has a microcontroller 10. An analog-to-digital (A/D) converting section (ADC) 11 of the microcontroller 10 detects and converts a voltage between a predetermined voltage line such as a line having the same voltage as that of the input terminal IN4 and a node between the resistor element R21 and the resistor element R22. The A/D converting section 11 generates and outputs a voltage signal as a digital signal based on the detected voltage to indicate the voltage between the input terminals IN3 and IN4. The microcontroller 10 and its software function to be described below can be replaced with a logic circuit that performs a same operation.

The power converting section B3 is further provided with a voltmeter Mv3 that monitors and detects a voltage supplied by the system power line SYS in time series in real time. In the present embodiment, the voltmeter Mv3 is provided with a resistor element R31 and a resistor element R32 connected in serial between the external line LL1 and the neutral line LN in the system power line SYS of the single-phase 3-wire type. By the resistor elements R31 and R32, the voltage between the external line LL1 and the neutral line LN of the system power line SYS is detected. An A/D converting section 13 of the microcontroller 10 generates and outputs a voltage signal as a digital signal based on the detected voltage, to indicate the voltage between the external line LL1 and the neutral line LN. Similarly, by resistor elements R33 and R34, a digital signal is generated and outputted to indicate a voltage between an external line L2 and the neutral line LN.

The power converting section B3 is further provided with a digital-to-analog (D/A) converting section DAC. The D/A converting section DAC is provided with an inverter INV and a filter circuit LC. The inverter INV can be realized by a typical voltage inverter including switching elements Tr1 to Tr4 such as power MOS transistors, IGBTs, SiC power devices, forming a plurality of arms. ON/OFF timing of each of the switching elements Tr1 to Tr4 is determined by a PWM signal for pulse width modulation control generated by a PWM timer 12. The inverter INV converts the power outputted from the voltage control section B2 into power suitable for the system interconnection and then outputs it.

A high-frequency component of the power outputted from the inverter INV is removed by the filter circuit LC. The filter circuit LC can be formed by a typical low-pass filter including inductors L1 and L2 and capacitors CP1 and CP2. The power outputted from the filter circuit LC is supplied to the system power line SYS. In the example of FIG. 3, output-side wires of the filter circuit LC are connected to the external lines LL1 and LL2 and the neutral line LN of the single-phase 3-wire AC power line SYS for the purpose of power supply to the system power line SYS.

The microcontroller 10 is provided with a signal processing section 21. The signal processing section 21 processes the digital voltage signals outputted from the A/D converting section 13 to generate detection voltage values. The signal processing section 21 integrates or adds the current detection voltage value and at least one previous detection voltage values (e.g. the detection voltage value for the last time) with the same phase and then calculates average values of the integration result when the system power line SYS is an AC power line. By this function, the average voltage values with the same phases over a predetermined amount of periods to the current time are stored in an L1 table and an L2 table. The microcontroller 10 is further provided with an average voltage value table generating section 22 that generates an average voltage value table 20 for storing the obtained average voltage values when the detection voltage values are generated. The generated average voltage value table 20 is held in a RAM 14. The average voltage values between the lines LL1 and LN are stored in the L1 table, and the average voltage values between the lines LL21 and LN are stored in the L2 table. In the average voltage value table 20, respective phases and average voltage values at the respective phases for one period of a voltage waveform of the system power line SYS are stored.

The average voltage value table generating section 22 calculates average voltage values by use of the detection voltage values when acquiring the detection voltage values, and stores the calculation result into the average voltage value table 20. The calculated average voltage values are further used for operation of the PWM timer 12. The PWM timer 12 generates the pulse PWM signal for the PWM control so as to follow the average voltage values and then transmits it to the inverter INV via an output section 12-1. As a result of this, the power outputted from the voltage control section B2 is converted by the power converting section B3, into a the power having a voltage waveform that follows the voltage waveform of the system power line SYS in real time and then interconnected to the system power line SYS.

With such a control, the power converting section B3 is feedback-controlled in such a manner that the power outputted from the DC power generator B1 has the voltage waveform of the power of the system power line SYS. Thus, the control by the microcontroller 10 in the present embodiment makes it possible to realize power system interconnection regardless of a type of power transmission by the system power line SYS.

The system power line SYS is of a single-phase 3-wire type in the example of FIG. 3, but it is possible to achieve system interconnection by the same control in any of cases where a type of power transmission adopted by the system is single-phase 2-wire AC power transmission, 3-phase 3-wire AC power transmission, and further DC power transmission. In the case of the 3-phase 3-wire AC power transmission, the power outputted from the voltage control section B2 is converted into a 3-phase AC power by the power converting section B3, and the same voltage detection, generation of the average voltage value table 20, and PWM control as those described above are performed for each of U, V, and W phases whereby the system interconnection is performed.

When the system power line SYS adopts the DC power transmission, the microcontroller 10 stores a preset period. Upon receiving the detection voltage values from the A/D converting section 13, the average voltage value table generating section 22 calculates an average voltage value of the received current detection voltage value and a previous detection voltage value(s) with a same phase. The inverter INV is subjected to the PWM-control based on the calculated average voltage value. Period setting is performed, taking noise or the like into consideration. For example, when the system power line SYS has more noise, an influence of the noise can be suppressed by setting a longer period at time of initial setting of the microcontroller 10. When the system power line SYS adopts the DC power transmission, the voltage boosting chopper circuit or the voltage reducing chopper circuit can be used as the voltage converter C3.

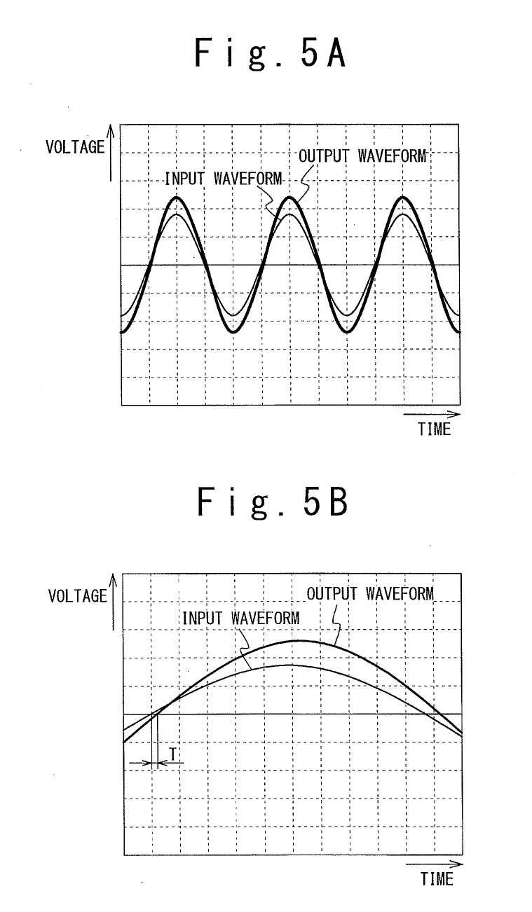

Next, a delay time compensation function of the power system interconnection system will be described. In the voltage converter C3, a delay time is generated by the low-pass filter that smoothes a pulse-like AC power generated by the inverter INV. FIG. 5A shows an example of an input waveform and an output waveform. In this figure, the input waveform is not an output itself of the inverter INV, but is indicated by being formed into a sine-wave. FIG. 5B is a partially enlarged view, indicating that a phase of the output waveform is delayed behind a phase of the input waveform by a period T. Since the input waveform is controlled to follow the waveform on the system power line SYS, it is preferable that the period T be substantially zero for optimum system interconnection.

The microcontroller 10 includes a phase delay storage section 23 in which a delay time T of the filter circuit LC is previously stored. The delay time T is known at the time of designing the power converting section B3, and thus an operator stores the delay time T into the phase delay storage section 23 at the time of initial setting of the microcontroller 10. The PWM timer 12 reads from the average voltage value table 20 based on the delay time T, an average voltage value with the phase at the time later by +T with respect to the current detection voltage value of the system power line SYS. The PWM timer 12 outputs the PWM signal for the PWM control based on this average voltage value, to compensate a phase delay. With this control, the inverter INV generates a power of a voltage waveform having a phase earlier by the time T than the voltage waveform of the system power line SYS. The phase of this voltage waveform is delayed by the time T by the filter circuit LC. As a result of this, the power converting section B3 can generate the power of the voltage waveform of the same phase as that of the system power line SYS to achieve the system interconnection.

Upon performing such a control, the DC power generator B1 operates with a maximum power efficiency. Thus, by using a voltage V2(t) acquired by the voltmeter Mv2 at given time t and a voltage V3 (t+T) generated to be delayed by +T, a PWM duty ratio set by the PWM timer 12 can be expressed in the following equation:

(PWM duty ratio)=V2(t)/V3(t+T)

The microcontroller 10 controls the inverter INV by performing such a calculation in real time.

With the configuration described above, the following advantages are obtained: (1) it is possible to achieve the power system interconnection not based on assumption that the system has AC power, and (2) it is possible to reduce the delay of the voltage signal by the LC filter (theoretically to zero).

As a result of this, power loss can be suppressed for the system. Further, not only the AC power but also DC power can be supported.

The signal processing section 21 can obtain an average voltage value through multiplication or division, and can use a bit shift operation to speed up the average value calculation. In this case, the number of times of integration, that is, the number of voltage values to be added is set to the factorial of 2. A binary value of an integration value of voltage values with the same phase for this number is bit-shifted to calculate the average voltage value at high speed.

The signal processing section 21 further includes a function of removing an abnormality detection point of the voltage signal. For example, when the voltage signal in a predetermined time period indicates a change equal to or greater than a predetermined value, as compared with a change before and after that time period, the signal processing section 21 determines that the voltage signal within this predetermined time period is abnormal. The voltage signal determined to be abnormal is removed upon the calculation of the average voltage value. The signal processing section 21 further can detect and store a zero-cross time of the voltage waveform of the system power line SYS based on the voltage signal, and can recognize a phase of a voltage of the system based on this zero-cross time. The signal processing section 21 further can make fine adjustment of the detection voltage value in a manner such that the detection voltage value is stored at an appropriate phase position in the average voltage value table 20 based on this phase recognition.

It is preferable that the signal processing section 21 further includes a function of performing the following common multiple process. The signal processing section 21 calculates a synchronization period that is a common multiple (preferably, smallest common multiple) of a PWM setting period (a period between rising timing of pulses of the PWM signal for PWM control) and a period of the system power line SYS. What is recognized through this calculation is timing T2 at which, when the current rising timing of the PWM signal for the PWM control corresponds to a given phase ·1 of the system power at given timing T1, the next rising timing of the PWM signal for the PWM control and the phase ·1 of the system power are coincident with each other. The average voltage value table generating section 22 stores the average voltage values of the detection voltage values during one period from T1 to T2 in the average voltage value table 20. The signal processing section 21 extracts the average voltage value accurately corresponding to a current phase of the system power line SYS from the average voltage value table 20 and transfers it to the PWM timer 12. Thus, the inverter INV can be controlled in such a manner that it accurately corresponds to the current phase of the system power line SYS.

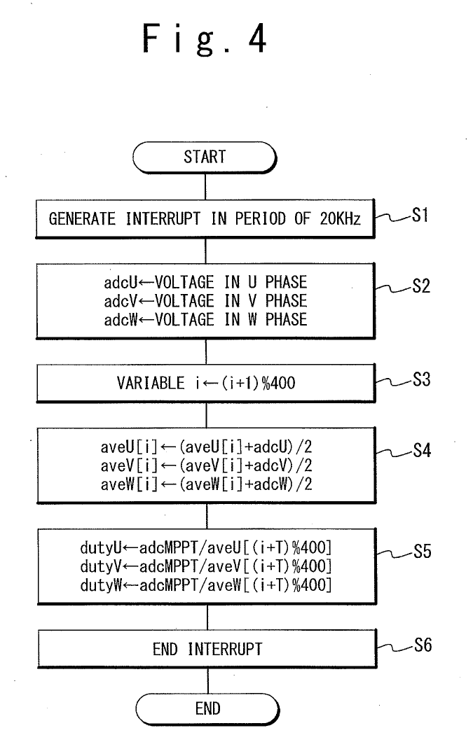

FIG. 4 is a flowchart showing an operation of the microcontroller 10 for calculating a set value by the PWM timer 12 that generates an inverter control signal when the above control is applied to interconnection with 3-phase AC system power transmission. First, symbols used in this flowchart will be described. The symbols adcU, adcV, and adcW denote current detection voltage values for a U phase, a V phase, and a W phase of the system power line detected by a voltmeter corresponding to the voltmeter Mv3 of FIG. 1.

In this example, a set frequency for the PWM control is 20 kHz and a frequency of the system is 50 Hz. In this case, a frequency corresponding to the period of smallest common multiple in the above description is 20 kHz. Thus, a sampling frequency of the A/D converting section 13 for the detection voltage values of the system power line SYS is set to be 20 kHz. In this case, since 20k/50=400, the average voltage value with the resolution of 400 samples per a period is stored into the average voltage value table 20.

The symbols aveU [i], aveV [i], and aveW [i] denote the average voltage values of the U phase, the V phase, and the W phase in the average voltage value tables 20. The symbol aveU [i] is an array variable having elements from the symbols aveU [1] to aveU [400], and the same is applied to the symbols aveV [i] and aveW [i]. The symbol i is a phase interval value in the average voltage value table 20, and incremented in synchronization with the sampling frequency. The average voltage value table generating section 22 is realized by software which generates such array variables and substitutes values for the elements thereof.

The symbol dutyU is a control signal for 3-phase driving that is outputted to the inverter INV by the microcontroller 10. Arm generating an AC voltage for the U-phase of the inverter INV is subjected to the PWM control with a duty ratio indicated by the symbol dutyU. The symbols dutyV and dutyW are the same duty ratios for the PWM control for the V phase and the W phase, respectively.

The symbol adcMPPT is an input voltage of the power converting section B3 detected by the voltmeter Mv2 located at a stage previous to the inverter INV. When the DC power generator B1 is a power generator such as a PV (photovoltaic) panel, a wind power generator, geothermal power generation, and cogeneration, having great variation in generated power, the symbol adcMPPT denotes a voltage of power generated when these are under the maximum power point tracking (MPPT) control.

The symbol T denotes a delay time generated at a stage subsequent to the inverter INV such as the filer LC. The symbol T is an integer in units of the phase interval values in the average voltage value table 20. The symbol % is a symbol of an operator for a remainder value. That is, a symbol A%B denotes a remainder value in a calculation that A is divided by B.

The microcontroller 10 performs initialization as shown below at the time of activation of the power system interconnection system. A variable i is set to be i=0 when a U phase voltage of a power system is 0V. All elements of the array variables declared with the symbols aveU [400], aveV [400], and aveW [400] are set to be zero. The delay time T in the phase delay storage section 23 is set to be a predetermined value. For the setting of the delay time T, a constant number not related to the initialization may be used.

### Step S1:

The microcontroller 10 performs an interrupt process with the frequency of 20 kHz.

### Step S2:

The A/D converting section 13 acquires a voltage of each line of the system power line to a predetermined constant voltage line from the voltmeter Mv3 in the microcontroller 10 and subjects it to A/D conversion to generate the detection voltage values adcU, adcV, and adcW of the respective phases.

### Step S3:

(i+1)%400 is calculated and a result of this is newly defined as a value of the variable i.

### Step S4:

The average voltage value table generating section 22, for each of the phases, calculates average voltage values between the voltage values stored in the average voltage value table 20 and the detection voltage values generated in step S2, and updates a value of the i^{th} element of the average voltage value table 20 for each phase.

### Step S5:

The microcontroller 10 calculates, by using the following equations, the duty ratios for the respective phases for the purpose of subjecting the inverter INV to the PWM control:

dutyU=adcMPPT/aveU [(i+T)%400],

dutyV=adcMPPT/aveV [(i+T)%400], and

dutyW=adcMPPT/aveW [(i+T)%400].

A term aveU [(i+T)%400] is the average voltage value in a previous period and also an average voltage value having a phase earlier by the phase of +T than the current phase of the system voltage in the voltage average value table 20 for the U phase. As a result of subjecting the inverter INV to the PWM control in response to a command value dutyU of this duty ratio, an AC voltage waveform is outputted in which a phase delay generated by the filter circuit LC is previously compensated.

### Step S6:

The microcontroller 10 ends the interrupt process and waits for the next operation or the next interrupt process for performing control described above.

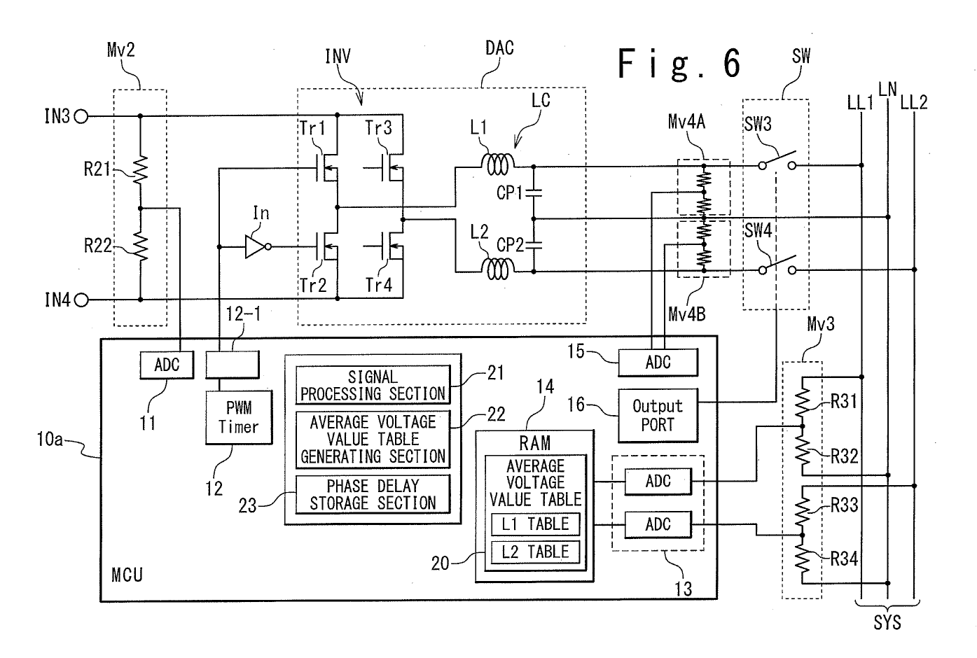

Next, referring to FIG. 6, a second embodiment of the present invention will be described. An overall configuration of the power system interconnection system of the present embodiment is the same as the configuration shown in FIG. 1. However, it should be noted that the power converting section B3 has a configuration shown in FIG. 6, which is different from the configuration in FIG. 3. In the present embodiment, a microcontroller 10a automatically detects a phase delay time due to the filter circuit LC or the like provided between an output of the inverter INV and the system power line SYS and compensates for the phase delay time.

In the present embodiment, voltmeters Mv4A and Mv4B are arranged on a subsequent stage side of the filter circuit LC to detect voltages between different output terminals. Further, a breaker SW is arranged on a more subsequent side of the voltmeters Mv4A and Mv4B, to block power between an internal circuit of the power system interconnection system and the system power line SYS. The breaker SW includes system output switches SW3 and SW4.

The microcontroller 10a has an A/D converting section 15 and an output port 16 in addition to the configuration of the microcontroller 10 of FIG. 3. The A/D converting section 15 generates digital signals of detection voltage values indicating the voltages detected by the voltmeters Mv4A and Mv4B. The output port 16 outputs a signal for controlling ON/OFF of the breaker SW.

In such a power system interconnection system, at time of initial setting of the microcontroller 10a, the output port 16 controls the breaker SW to block interconnection with the system. Thereafter, the control described with reference to steps S1 to S6 of FIG. 4 is performed. It should be noted that a delay time is set to be T=0.

The A/D converting section 15 generates the detection voltage values in a blocked state based on the voltages generated by the voltmeters Mv4A and Mv4B. The microcontroller 10a estimates a delay time by comparing the detection voltage values detected by the voltmeters Mv4A and Mv4B and generated by the A/D converting section 15 and detection voltage values generated by the A/D converting section 13 and stored in the average voltage value table 20. The delay time is stored in the phase delay storage section 23. The delay time estimation can be performed by using a typical method such as a PID correction method. The microcontroller 10a stores the delay time estimated in this manner.

Then, the stored delay time is set as the delay time T, and the same control as the control described with reference to FIG. 4 is performed. After the delay time T is set and the PWM control is started based on the delay time T, the microcontroller 10a controls the breaker SW through the output port 16 to connect the power system interconnection system and the system power line SYS. Such a control makes it possible to automatically perform the setting of the delay time T without a previous write process performed by a user.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A power system interconnection system comprising:
a voltage detecting section configured to detect voltage values of a power system line to generate detection voltage values;
a PWM signal generating section configured to generate a PWM signal such that an output voltage follows said detection voltage values; and
a voltage converting circuit configured to generate and supply said output voltage to said power system line by performing a pulse-width-modulation control on the power supplied from a power supply based on said PWM signal.

2. The power system interconnection system according to claim 1, wherein said PWM signal generating section generates said PWM signal to follow an average voltage value of voltage values which contains a current one of said detection voltage value and a previous one of said detection voltage value of a same phase as that of said system power line.

3. The power system interconnection system according to claim 2, further comprising:
an average voltage table generating section configured to generate a table, calculate an average voltage value when said voltage detecting section generates said detection voltage value and store the average voltage value in said table with respect to each phase.

4. The power system interconnection system according to claim 3, wherein said average voltage table generating section stores in said table, the average voltage values during a period which is equivalent to a common multiple of a period of said pulse width modulation control and a period of said system power line.

5. The power system interconnection system according to claim 1, further comprising:
a phase delay storage section configured to store a value of a phase delay when said voltage converting circuit generates said output voltage,
wherein said PWM signal generating section generates said PWM signal to compensate said phase delay stored in said phase delay storage section.

6. The power system interconnection system according to claim 1, further comprising:
a breaker configured to block off interconnection between said voltage converting circuit and said system power line; and
a phase delay detecting section configured to detect a phase delay of said output voltage generated by said voltage converting circuit to the voltage on said system power line in a state that said breaker blocks off the interconnection between said voltage converting circuit and said system power line,
wherein said PWM signal generating section generates said PWM signal such that said phase delay detected by said phase delay detecting section is compensated.

7. The power system interconnection system according to claim 1, wherein said system power line transmits DC power.

8. A microcontroller comprising:
a PWM signal generating section configured to generate a PWM signal such that an output voltage follows detection voltage values,
wherein a voltage detecting section detect voltage values of a power system line to generate said detection voltage values, and
a voltage converting circuit generates and supplies said output voltage to said power system line by performing a pulse-width-modulation control on the power supplied from a power supply based on said PWM signal.

9. The microcontroller according to claim 8, wherein said PWM signal generating section generates said PWM signal to follow an average voltage value of voltage values which contains a current one of said detection voltage value and a previous one of said detection voltage value of a same phase as that of said system power line.

10. The microcontroller according to claim 9, further comprising:
an average voltage table generating section configured to generate a table, calculate an average voltage value when said voltage detecting section generates said detection voltage value and store the average voltage value in said table with respect to each phase.

11. The microcontroller according to claim 10, wherein said average voltage table generating section stores in said table, the average voltage values during a period which is equivalent to a common multiple of a period of said pulse width modulation control and a period of said system power line.

12. The microcontroller according to claim 8, further comprising:
a phase delay storage section configured to store a value of a phase delay when said voltage converting circuit generates said output voltage,
wherein said PWM signal generating section generates said PWM signal to compensate said phase delay stored in said phase delay storage section.

13. The microcontroller according to claim 8, wherein a breaker blocks off interconnection between said voltage converting circuit and said system power line, and
a phase delay detecting section detects a phase delay of said output voltage generated by said voltage converting circuit to the voltage on said system power line in a state that said breaker blocks off the interconnection between said voltage converting circuit and said system power line,
wherein said PWM signal generating section generates said PWM signal such that said phase delay detected by said phase delay detecting section is compensated.

14. The microcontroller according to claim 8, wherein said system power line transmits DC power.

15. A power converting method comprising:
detecting a voltage of a system power line to generate detection voltage values;
generating a PWM signal for an output voltage to follow said detection voltage values; and
outputting said PWM signal to a voltage converting circuit which generates and supplies said output voltage to said system power line by performing PWM modulation on power supplied from a power supply based on said PWM signal.
